(19) United States
(12) Patent Application Publication
(10) Pub. No.: US 2003/0233198 A1
(43) Pub. Date: Dec. 18, 2003

(54) Multivariate data analysis method and uses thereof

(76) Inventors: Genichi Taguchi, West Bloomfield, MI (US); Rajesh Jugulum, Weymouth, MA (US); Shin Taguchi, West Bloomfield, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/293,092

(22) Filed: Nov. 13, 2002

Related U.S. Application Data
(60) Provisional application No. 60/338,574, filed on Nov. 13, 2001.

(51) Int. Cl. G06F 15/00

(52) U.S. Cl. 702/32; 702/182

(57) ABSTRACT

A process involves collecting data relating to a particular condition and parsing the data from an original set of variables into subsets. For each subset defined, Mahalanobis distances are computed for known normal and abnormal values and the square root of these Mahalanobis distances is computed. A multiple Mahalanobis distance is calculated based upon the square root of Mahalanobis distances. Signal to noise ratios are obtained for each run of an orthogonal array in order to identify important subsets. This process has applications in identifying important variables or combinations thereof from a large number of potential contributors to a condition.

### RELATED APPLICATION

This application claims priority of U.S. Provisional Patent Application Serial No. 60/338,574 filed Nov. 13, 2001, which is incorporated herein by reference.

### BACKGROUND OF THE INVENTION

Design of a good information system based on several characteristics is an important requirement for successfully carrying out any decision-making activity. In many cases though a significant amount of information is available, we fail to use such information in a meaningful way. As we require high quality products in day-to-day life, it is also required to have high quality information systems to make robust decisions or predictions. To produce high quality products, it is well established that the variability in the processes must be reduced first. Variability can be accurately measured and reduced only if we have a suitable measurement system with appropriate measures. Similarly, in the design of information systems, it is essential to develop a measurement scale and use appropriate measures to make accurate predictions or decisions.

Usually, information systems deal with multidimensional characteristics. A multidimensional system could be an inspection system, a medical diagnosis system, a sensor system, a face/voice recognition system (any pattern recognition system), credit card/loan approval system, a weather forecasting system or a university admission system. As we encounter these multidimensional systems in day-to-day life, it is important to have a measurement scale by which degree of abnormality (severity) can be measured to take appropriate decisions. In the case of medical diagnosis, the degree of abnormality refers to the severity of diseases and in the case of credit card/loan approval system it refers to the ability to pay back the balance/loan. If we have a measurement scale based on the characteristics of multidimensional systems, it greatly enhances the decision maker's ability to take judicious decisions. While developing a multidimensional measurement scale, it is essential to keep in mind the following: 1) Having a base or reference point to the scale, 2) validation of the scale and 3) selection of useful subset of variables with suitable measures for future use.

There are several multivariate methods. These methods are being used in multidimensional applications, but still there are incidences of false alarms in applications like weather forecasting, airbag sensor operation and medical diagnosis. These problems could be because of not having an adequate measurement system with suitable measures to determine or predict the degree of severity accurately.

A process for multivariate data analysis includes the steps of using an adjoint matrix to compute a new distance for a data set in a Mahalanobis space. The relation of a datum relative to the Mahalanobis space is then determined.

A medical diagnosis process includes defining a set of variables relating to a patient condition and collecting a data set of the set of variables for a normal group. Standardized values of the set of variables of the normal group are then computed and used to construct a Mahalanobis space. A distance for an abnormal value outside the Mahalanobis space is then computed. Important variables from the set of variables are identified based on orthogonal arrays and signal to noise ratios. Subsequent monitoring of conditions occurs based upon the important variables.

### BRIEF DESCRIPTION OF THE DRAWINGS

FIG. 1 is a schematic illustrating a multi-dimensional diagnosis system of the present invention;

FIG. 2 is a graphical representation of a voice recognition pattern according to the present invention parsed into the letter k subsets that correspond to k patterns numbered from 1,2, . . . k where each pattern starts at a low value, reaches a maximum and then again returns to the low value;

FIG. 3 is a graphical representation of MDAs values for normal and abnormal values for nine separate data points; and

FIG. 4 is a graphical representation of MDAs values for normal versus abnormal values with important variable usage, for the data of FIG. 3.

### DETAILED DESCRIPTION OF THE INVENTION

The inventive method helps develop multidimensional measurement scale by integrating mathematical and statistical concepts such as Mahalanobis distance and Gram-Schmidt's orthogonalization method, with the principles of quality engineering or Taguchi Methods.

One of the main objectives of the present invention is to introduce a scale based on all input characteristics to measure the degree of abnormality. In the case of medical diagnosis, for example, the aim is to measure the degree of severity of each disease based on this scale. To construct such a scale, Mahalanobis distance (MD) is used. MD is a squared distance (also denoted as D²) and is calculated for j^{th} observation, in a sample of size n with k variables, by using the following formula:

MDⱼ=Dⱼ²=(l/k)Z′ᵢⱼC⁻¹Zᵢⱼ (1)

Where,

j=1 to n

$$\begin{matrix}{Z}_{i j} = ( {z}_{1 j} , {z}_{2 j} , … , {z}_{k j} ) \\ = standardized vector obtained by standardized values of {X}_{i j} \\ ( i = 1 … k )\end{matrix}$$

Zᵢⱼ=(Xᵢⱼ−m₁)/s₁

Xᵢⱼ=value of i^{th} characteristic in j^{th} observation

m₁=mean of i^{th} characteristic

s₁=s.d. of i^{th} characteristic

k=number of characteristics/variables

′=transpose of the vector

C⁻¹=inverse of the correlation matrix

There is also an alternate way to compute MD values using Gram-Schmidt's orthogonalization process. It can be seen that MD in Equation (1) is obtained by scaling, that is by dividing with k, the original Mahalanobis distance. MD can be considered as the mean square deviation (MSD) in multidimensional spaces. The present invention focuses on constructing a normal group, or in the application of medical diagnosis a healthy group, from a data population, called Mahalanobis Space (MS). Defining the normal group or MS is the choice of a specialist conducting the data analysis. In case of medical diagnosis, the MS is constructed only for the people who are healthy and in case of manufacturing inspection system, the MS is constructed for high quality products. Thus, MS is a database for the normal group consisting of the following quantities:

m₁=mean vector

s₁=standard deviation vector

C⁻¹=inverse of the correlation matrix.

Since MD values are used to define the normal group, this group is designated as the Mahalanobis Space. It can be easily shown, with standardized values, that MS has zero point as the mean vector and the average MD as unity. Because the average MD of MS is unity, MS is also called as the unit space. The zero point and the unit distance are used as reference point for the scale of normalcy relating to inclusion of a subject within MS. This scale is often operative in identifying the abnormal conditions. In order to validate the accuracy of the scale, different kinds of known conditions outside MS are used. If the scale is good, these conditions should have MDs that match with decision maker's judgment. In this application, the conditions outside MS are not considered as a separate group (population) because the occurrence of these conditions are unique, for example a patient may be abnormal because of high blood pressure or because of high sugar content. Because of this reason, the same correlation matrix of the MS is used to compute the MD values of each abnormal. MD of an abnormal point is the distance of that point from the center point of MS.

In the next phase of the invention, orthogonal arrays (OAs) and signal-to-noise (S/N) ratios are used to choose the relevant variables. There are different kinds of S/N ratios depending on the prior knowledge about the severity of the abnormals.

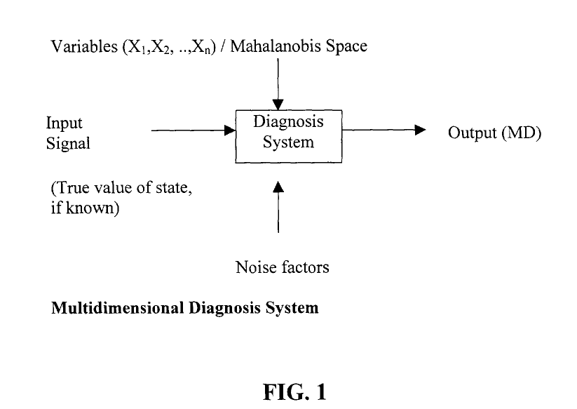

A typical multidimensional system used in the present invention is as shown in FIG. 1, where X₁,X₂, . . . ,Xₙ correspond to the variables that provide a set of information to make a decision. Using these variables, MS is constructed for the healthy group, which becomes the reference point for the measurement scale. After constructing the MS, the measurement scale is validated by considering the conditions outside MS. These outside conditions are typically checked with the given input signals and in the presence of noise factors (if any). If the noise factors are present, a correct decision has to be made about the state of the system. In the context of multivariate diagnosis system, it would be appropriate to consider two types of noise conditions. They are 1) active noise and 2) criminal noise. Example for active noise condition is change in usage environment such as conditions in different manufacturing environments or different hospitals and the example for criminal noise conditions are unexpected conditions such as terrorist attacks on Sep. 11, 2001 in which the system is operating. It is important to design multivariate information systems considering these two types of noise conditions. In FIG. 1, the input signal is the true value of the state of the system, if known. The output (MD) should be as close to the true state of the system (input signal) as possible. In most applications, it is not easy to obtain the true states of the system. In such cases, the working averages of the different classes, where the classes correspond to the different degrees of severity can be considered as the input signals.

After validating the measurement scale, OAs and S/N ratios are used to identify the variables of importance. OAs are used to minimize the number of variable combinations by allocating the variables to the columns of the array. The OAs use only the presence and the absence of the variables as the levels. Therefore, only two level arrays are used in MTS. To identify the variables of importance, S/N ratios are used.

The inventive process can illustratively be applied to a multidimensional system in four stages. The steps in each exemplary stage are listed below:

Stage I: Construction of a Measurement Scale with Mahalanobis Space (Unit Space) as the Reference

Define the variables that determine the healthiness of a condition. For example, in medical diagnosis application, the doctor has to consider the variables of all diseases to define a healthy group. In general, for pattern recognition applications, the term “healthiness” must be defined with respect to “reference pattern”.

Collect the data on all the variables from the healthy group.

Compute the standardized values of the variables of the healthy group.

Compute MDs of all observations. With these MDs, we can define the zero point and the unit distance.

Use the zero point and the unit distance as the reference point or base for the measurement scale.

Stage II: Validation of the Measurement Scale

Identify the abnormal conditions. In medical diagnosis applications, the abnormal conditions refer to the patients having different kinds of diseases. In fact, to validate the scale, we may choose any condition outside MS.

Compute the MDs corresponding to these abnormal conditions to validate the scale. The variables in the abnormal conditions are normalized by using the mean and s.d.s of the corresponding variables in the healthy group. The correlation matrix or set of Gram-Schmidt's coefficients, if Gram-Schmidt's method is used, corresponding to the healthy group is used for finding the MDs of abnormal conditions.

If the scale is good, the MDs corresponding to the abnormal conditions should have higher values. In this way the scale is validated. In other words, the MDs of conditions outside MS must match with judgment.

Stage III: Identify the Useful Variables (Developing Stage)

Find out the useful set of variables using orthogonal arrays (OAs) and S/N ratios. S/N ratio, obtained from the abnormal MDs, is used as the response for each combination of OA. The useful set of variables is obtained by evaluating the “gain” in S/N ratio.

Stage IV: Future Diagnosis with Useful Variables

Monitor the conditions using the scale, which is developed with the help of the useful set of variables. Based on the values of MDs, appropriate corrective actions can be taken. The decision to take the necessary actions depends on the value of the threshold.

In case of medical diagnosis application, above steps have to be performed for each kind of disease in the subsequent phases of diagnosis. It is appreciated that many additional applications for the present invention exist as illustratively recited in “The Mahalanobis Taguchi System” by G. Taguchi, S. Chowdhury and Y. Wu, McGraw-Hill, 2001.

According to the present invention, an adjoint matrix method is used to calculate MD values.

If A is a square matrix, the inverse can be computed for square matrices only, then its inverse A⁻¹ is given as:

A⁻¹=(1/det. A)A_{adj} (2)

Where,

A_{adj} is called adjoint matrix of A. Adjoint matrix is transpose of cofactor matrix, which is obtained by cofactors of all the elements of matrix A, det. A is called determinant of the matrix A. The determinant is a characteristic number (scalar) associated with a square matrix. A matrix is said to be singular if its determinant is zero.

As mentioned before, the determinant is a characteristic number associated with a square matrix. The importance of determinant can be realized when solving a system of linear equations using matrix algebra. The solution to the system of equations contains inverse matrix term, which is obtained by dividing the adjoint matrix by determinant. If the determinant is zero then, the solution does not exist.

Let us consider a 2×2 matrix as shown below:

$$A = [ \begin{matrix}{a}_{11} & {a}_{12} \\ {a}_{21} & {a}_{22}\end{matrix} ]$$

The determinant of this matrix is a₁₁a₂₂-a₁₂a₂₁.

Now let us consider a 3×3 matrix as shown below:

$$A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$

The determinant of A can be calculated as:

det. A=a₁₁A₁₁+a₁₂A₁₂+a₁₃A₁₃

Where,

A₁₁ =(a₂₂a₃₃−a₂₃a₃₂); A₁₂=−(a₂₁a₃₃−a₂₃a₃₁); A₁₃=(a₂₁a₃₂−a₂₂a₃₁) are called as cofactors of the elements a₁₁,a₁₂, and a₁₃ of matrix A respectively. Along a row or a column, the cofactors will have alternate plus and minus sign with the first cofactor having a positive sign.

The above equation is obtained by using the elements of the first row and the sub matrices obtained by deleting the rows and columns passing through these elements. The same value of determinant can be obtained by using other rows or any column of the matrix. In general, the determinant of a n×n square matrix can be written as:

det. A=aᵢ₁Aᵢ₁+aᵢ₂Aᵢ₂+. . . +aᵢₙAᵢₙ along any row index i, where, i=1,2, . . . ,n

or

det. A=a₁ⱼA₁ⱼ+a₂ⱼA₂ⱼ+. . . +aₙⱼAₙⱼ along any column index j, where, j=1,2, . . . ,n

Cofactor

From the above discussion, it is clear that the cofactor of Aᵢⱼ of an element aᵢⱼ is the factor remaining after the element aᵢⱼ is factored out. The method of computing the co-factors is explained above for a 3×3 matrix. Along a row or a column the cofactors will have alternate signs of positive and negative with the first cofactor having a positive sign.

Adjoint Matrix of a Square Matrix

The adjoint of a square matrix A is obtained by replacing each element of A with its own cofactor and transposing the result.

Again, let us consider a 3×3 matrix as shown below:

$$A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$

The cofactor matrix containing cofactors (Aᵢⱼs) of the elements of the above matrix can be written as:

$$A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$

The adjoint of the matrix A, which is obtained by transposing the cofactor matrix, can be written as:

$$Adj . A = [ \begin{matrix}{a}_{11} & {a}_{21} & {a}_{31} \\ {a}_{12} & {a}_{22} & {a}_{32} \\ {a}_{131} & {a}_{23} & {a}_{33}\end{matrix} ]$$

Inverse Matrix

The inverse of matrix A (denoted as A⁻¹) can be obtained by dividing the elements of its adjoint by the determinant.

Singular and Non-Singular Matrices

If the determinant of a square matrix is zero then, it is called a singular matrix. Otherwise, the matrix is known as non-singular.

The present invention is applied to solve a number of longstanding data analysis problems. These are exemplified as follows.

Multi-Collinearity Problems

Multi-collinearity problems arise out of strong correlations. When there are strong correlations, the determinant of correlation matrix tends to become zero thereby making the matrix singular. In such cases, the inverse matrix will be inaccurate or cannot be computed (because determinant term is in the denominator of Equation 2). As a result, scaled MDs will also be inaccurate or cannot be computed. Such problems can be avoided if we use a matrix form, which is not affected by determinant term. From Equation (2), it is clear that adjoint matrix satisfies this requirement.

MD values in MTS method are computed by using inverse of the correlation matrix (C⁻¹, where C is correlation matrix). In the present invention, the adjoint matrix is used to calculate the distances. If MDA denotes the distances obtained from adjoint matrix method, then equation for MDA can be written as:

MDAⱼ=(1/k)Zᵢⱼ′C_{adj}Zᵢⱼ (3)

Where,

j=1 to n

$$\begin{matrix}{Z}_{i j} = ( {z}_{1 j} , {z}_{2 j} , … , {z}_{k j} ) \\ = standardized vector obtained by standardized values of {X}_{i j} \\ ( i = 1 … k )\end{matrix}$$

Zᵢⱼ=(Xᵢⱼ−m₁)/s₁;

Xᵢⱼ=value of i^{th} characteristic in j^{th} observation

mᵢ=mean of i^{th} characteristic

s₁=s.d. of i^{th} characteristic

k=number of characteristics/variables

′=transpose of the vector

C_{adj}=adjoint of the correlation matrix.

The relationship between the conventional MD and the MDAs in (3) can be written as:

MDⱼ=(1/det.C)MDAⱼ (4)

Thus, an MDA value is similar to a MD value with different properties, that is, the average MDA is not unity. Like in the case of MD values, MDA values represent the distances from the normal group and can be used to measure the degree of abnormalities. In adjoint matrix method also, the Mahalanobis space contains means, standard deviations and correlation structure of the normal or healthy group. Here, the Mahalanobis space cannot be called as unit space since the average of MDAs is not unity.

β-Adjustment Method

The present invention has applications in multivariate analysis in the presence of small correlation coefficients in correlation matrix. When there are small correlation coefficients, the adjustment factor β is calculated as follows.

$$\begin{matrix}β = 0 if r \leq 1 / √ n \\ β = 1 - \frac{1}{n - 1} ( \frac{1}{{r}^{2}} - 1 ) if r > 1 / √ n\end{matrix} \qquad ( 5 )$$

where r is correlation coefficient and n is sample size.

After computing β, the elements of the correlation matrix are adjusted by multiplying them with β. This adjusted matrix is used to carry out MTS analysis or analysis with adjoint matrix.

To explain the applicability of β-adjustment method, a Japanese doctor's, Dr. Kanetaka's, data on liver disease testing is used. The data contains observations of healthy group as well as of the conditions outside Mahalanobis space (MS). The healthy group (MS) is constructed based on observations on 200 people, who do not have any health problems. There are 17 abnormal conditions. This example is chosen since the correlation matrix in this case contains a few small correlation coefficients. The corresponding β-adjusted correlation matrix (using Equation 5) is as shown in Table 1.

TABLE 1
β-adjusted correlation matrix

| | X₁ | X2 | X₃ | X4 | X₅ | X6 | X₇ | X8 | X₉ |
|---|---|---|---|---|---|---|---|---|---|
| X₁ | 1.000 | −0.281 | −0.261 | −0.392 | −0.199 | 0.052 | 0.000 | 0.185 | 0.277 |
| X₂ | −0.281 | 1.000 | 0.055 | 0.406 | 0.687 | 0.271 | 0.368 | −0.061 | 0.000 |
| X₃ | −0.261 | 0.055 | 1.000 | 0.417 | 0.178 | 0.024 | 0.103 | 0.002 | 0.000 |
| X₄ | −0.392 | 0.406 | 0.417 | 1.000 | 0.301 | 0.000 | 0.000 | 0.000 | −0.059 |
| X₅ | −0.199 | 0.687 | 0.178 | 0.301 | 1.000 | 0.332 | 0.374 | 0.000 | 0.000 |
| X₆ | 0.052 | 0.271 | 0.024 | 0.000 | 0.332 | 1.000 | 0.788 | 0.301 | 0.149 |
| X₇ | 0.000 | 0.368 | 0.103 | 0.000 | 0.374 | 0.788 | 1.000 | 0.109 | 0.000 |
| X₈ | 0.185 | −0.061 | 0.002 | 0.000 | 0.000 | 0.301 | 0.109 | 1.000 | 0.208 |
| X₉ | 0.277 | 0.000 | 0.000 | −0.059 | 0.000 | 0.149 | 0.000 | 0.208 | 1.000 |
| X₁₀ | −0.056 | 0.643 | 0.149 | 0.252 | 0.572 | 0.544 | 0.562 | 0.090 | 0.000 |
| X₁₁ | −0.067 | 0.384 | 0.155 | 0.197 | 0.419 | 0.528 | 0.500 | 0.206 | 0.113 |
| X₁₂ | 0.247 | −0.217 | 0.000 | −0.100 | 0.000 | 0.115 | 0.097 | 0.231 | 0.143 |
| X₁₃ | 0.099 | 0.252 | 0.127 | 0.050 | 0.355 | 0.305 | 0.362 | 0.054 | 0.080 |
| X₁₄ | 0.267 | −0.201 | 0.014 | −0.099 | 0.000 | 0.139 | 0.115 | 0.238 | 0.139 |
| X₁₅ | −0.276 | 0.885 | 0.117 | 0.353 | 0.640 | 0.307 | 0.387 | 0.000 | −0.007 |
| X₁₆ | 0.000 | 0.236 | −0.078 | 0.036 | 0.099 | 0.154 | 0.064 | 0.043 | −0.044 |
| X₁₇ | −0.265 | 0.796 | 0.173 | 0.403 | 0.671 | 0.347 | 0.425 | 0.000 | 0.000 |

| | X10 | X₁₁ | X12 | X₁₃ | X14 | X₁₅ | X16 | X₁₇ |
|---|---|---|---|---|---|---|---|---|
| X₁ | −0.056 | −0.067 | 0.247 | 0.099 | 0.267 | −0.276 | 0.000 | −0.265 |
| X₂ | 0.643 | 0.384 | −0.217 | 0.252 | −0.201 | 0.885 | 0.236 | 0.796 |
| X₃ | 0.149 | 0.155 | 0.000 | 0.127 | 0.014 | 0.117 | −0.078 | 0.173 |
| X₄ | 0.252 | 0.197 | −0.100 | 0.050 | −0.099 | 0.353 | 0.036 | 0.403 |
| X₅ | 0.572 | 0.419 | 0.000 | 0.355 | 0.000 | 0.640 | 0.099 | 0.671 |
| X₆ | 0.544 | 0.528 | 0.115 | 0.305 | 0.139 | 0.307 | 0.154 | 0.347 |
| X₇ | 0.562 | 0.500 | 0.097 | 0.362 | 0.115 | 0.387 | 0.064 | 0.425 |
| X₈ | 0.090 | 0.206 | 0.231 | 0.054 | 0.238 | 0.000 | 0.043 | 0.000 |
| X₉ | 0.000 | 0.113 | 0.143 | 0.080 | 0.139 | −0.007 | −0.044 | 0.000 |
| X₁₀ | 1.000 | 0.679 | 0.000 | 0.427 | 0.016 | 0.607 | 0.103 | 0.645 |
| X₁₁ | 0.679 | 1.000 | 0.128 | 0.329 | 0.120 | 0.436 | 0.000 | 0.457 |
| X₁₂ | 0.000 | 0.128 | 1.000 | 0.296 | 0.966 | −0.105 | 0.000 | 0.000 |
| X₁₃ | 0.427 | 0.329 | 0.296 | 1.000 | 0.304 | 0.249 | 0.000 | 0.339 |
| X₁₄ | 0.016 | 0.120 | 0.966 | 0.304 | 1.000 | −0.077 | 0.000 | 0.000 |
| X₁₅ | 0.607 | 0.436 | −0.105 | 0.249 | −0.077 | 1.000 | 0.262 | 0.768 |
| X₁₆ | 0.103 | 0.000 | 0.000 | 0.000 | 0.000 | 0.262 | 1.000 | 0.149 |
| X₁₇ | 0.645 | 0.457 | 0.000 | 0.339 | 0.000 | 0.768 | 0.149 | 1.000 |

With this matrix, MTS analysis is carried out with dynamic S/N ratio analysis and as a result the following useful variable combination was obtained: X₄-X₅-X₇-X₁₀-X₁₂-X₁₃-X₁₄-X₁₅-X₁₆-X₁₇. This combination is very similar to the useful variable set obtained without β-adjustment; the only difference is presence of variables X₇ and X₁₆.

With this useful variable set, S/N ratio analysis is carried out to measure improvement in overall system performance. From the Table 2, which shows system performance in the form of S/N ratios, it is clear that there is a gain of 0.91 dB units if useful variables are used instead of entire set of variables.

TABLE 2
S/N Ratio Analysis (β-adjustment method)

| | | |
|---|---|---|
| S/N ratio-optimal system | 43.81 | dB |
| S/N ratio-original system | 42.90 | dB |
| Gain | 0.91 | dB |

Multiple Mahalanobis Distance

Selection of suitable subsets is very important in multivariate diagnosis/pattern recognition activities as it is difficult to handle large datasets with several number of variables. The present invention applies a new metric called Multiple Mahalanobis Distance (MMD) for computing S/N ratios to select suitable subsets. This method is useful in complex situations, illustratively including voice recognition or TV picture recognition. In these cases, the number of variables run into the order of several hundreds. Use of MMD method helps in reducing the problem complexity and to make effective decisions in complex situations.

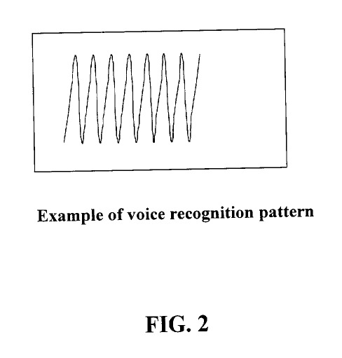

In MMD method, large number of variables are divided into several subsets containing local variables. For example, in a voice recognition pattern (as shown in FIG. 2), let there be k subsets. The subsets correspond to k patterns numbered from 1,2, . . . k. Each pattern starts at a low value, reaches a maximum and then again returns to the low value. These patterns (subsets) are described by a set of respective local variables. In MMD method, for each subset the Mahalanobis distances are calculated. These Mahalanobis distances are used to calculate MMD. Using abnormal MMDs, S/N ratios are calculated to determine useful subsets. In this way the complexity of the problems is reduced.

This method is also useful for identifying the subsets (or variables in the subsets) corresponding to different failure modes or patterns that are responsible for higher values of MDs. For example in the case of final product inspection system, use of MMD method would help to find out variables corresponding to different processes that are responsible for product failure.

If the variables corresponding to different subsets or processes cannot be identified then, decision maker can select subsets from the original set of variables and identify the best subsets required.

Exemplary Steps in Inventive Process

1. Define subsets from original set of variables. The subsets may contain variables corresponding to different patterns or failure modes. These variables can also be based on decision maker's discretion. The number of variables in the subsets need not be the same.

2. For each subset, calculate MDs (for normals and abnormals) using respective variables in them.

3. Compute square root of these MDs (MDs).

4. Consider the subsets as variables (control factors). The 4MDs would provide required data for these subsets. If there are k subsets then, the problem is similar to MTS problem with k variables. The number of normals and abnormals will be same as in the original problem. The analysis with 4MDs is exactly similar to that MTS method with original variables. The new Mahalanobis distance obtained based on square root of MDs is referred to as Multiple Mahalanobis Distance (MMD).

5. With the MMDs, S/N ratios are obtained for each run of an orthogonal array. Based on gains in S/N ratios, the important subsets are selected.

### EXAMPLE 1

The adjoint matrix method is applied to liver disease test data considered earlier. For the purpose of better understanding of the discussion, correlation matrix, inverse matrix and adjoint matrix corresponding to the 17 variables are given in Tables 3, 4, and 5 respectively. In this case the determinant of the correlation matrix is 0.00001314.

The Mahalanobis distances calculated by inverse matrix method and adjoint matrix method (MDAs), are given in Table 6 (for normal group) and in Table 7 (for abnormal group). From the Table 6, it is clear that the average MDAs for normals do not converge to 1.0. MDAs and MDs are related according to the Equation (4).

TABLE 3
Correlation matrix

| | X1 | X2 | X3 | X4 | X5 | X6 | X7 | X8 | X9 |
|---|---|---|---|---|---|---|---|---|---|
| X1 | 1.000 | −0.297 | −0.278 | −0.403 | −0.220 | 0.101 | 0.041 | 0.208 | 0.293 |
| X2 | −0.297 | 1.000 | 0.103 | 0.416 | 0.690 | 0.287 | 0.379 | −0.108 | −0.048 |
| X3 | −0.278 | 0.103 | 1.000 | 0.427 | 0.202 | 0.084 | 0.139 | 0.072 | 0.011 |
| X4 | −0.403 | 0.416 | 0.427 | 1.000 | 0.315 | 0.038 | 0.056 | 0.010 | −0.106 |
| X5 | −0.220 | 0.690 | 0.202 | 0.315 | 1.000 | 0.345 | 0.385 | 0.063 | −0.057 |
| X6 | 0.101 | 0.287 | 0.084 | 0.038 | 0.345 | 1.000 | 0.790 | 0.316 | 0.177 |
| X7 | 0.041 | 0.379 | 0.139 | 0.056 | 0.385 | 0.790 | 1.000 | 0.143 | 0.068 |
| X8 | 0.208 | −0.108 | 0.072 | 0.010 | 0.063 | 0.316 | 0.143 | 1.000 | 0.229 |
| X9 | 0.293 | −0.048 | 0.011 | −0.106 | −0.057 | 0.177 | 0.068 | 0.229 | 1.000 |
| X10 | −0.104 | 0.647 | 0.177 | 0.269 | 0.578 | 0.550 | 0.568 | 0.129 | 0.065 |
| X11 | −0.112 | 0.395 | 0.182 | 0.219 | 0.429 | 0.535 | 0.507 | 0.227 | 0.147 |
| X12 | 0.264 | −0.237 | 0.070 | −0.136 | 0.012 | 0.148 | 0.134 | 0.250 | 0.171 |
| X13 | 0.135 | 0.269 | 0.158 | 0.100 | 0.367 | 0.320 | 0.373 | 0.103 | 0.121 |
| X14 | 0.283 | −0.222 | 0.078 | −0.135 | 0.032 | 0.168 | 0.148 | 0.257 | 0.168 |
| X15 | −0.292 | 0.886 | 0.150 | 0.365 | 0.644 | 0.321 | 0.398 | −0.063 | −0.075 |
| X16 | −0.019 | 0.254 | −0.119 | 0.091 | 0.135 | 0.181 | 0.109 | 0.095 | −0.096 |
| X17 | −0.282 | 0.798 | 0.198 | 0.413 | 0.675 | 0.359 | 0.435 | −0.015 | −0.061 |

| | X10 | X11 | X12 | X13 | X14 | X15 | X16 | X17 |
|---|---|---|---|---|---|---|---|---|
| X1 | −0.104 | −0.112 | 0.264 | 0.135 | 0.283 | −0.292 | −0.019 | −0.282 |
| X2 | 0.647 | 0.395 | −0.237 | 0.269 | −0.222 | 0.886 | 0.254 | 0.798 |
| X3 | 0.177 | 0.182 | 0.070 | 0.158 | 0.078 | 0.150 | −0.119 | 0.198 |
| X4 | 0.269 | 0.219 | −0.136 | 0.100 | −0.135 | 0.365 | 0.091 | 0.413 |
| X5 | 0.578 | 0.429 | 0.012 | 0.367 | 0.032 | 0.644 | 0.135 | 0.675 |
| X6 | 0.550 | 0.535 | 0.148 | 0.320 | 0.168 | 0.321 | 0.181 | 0.359 |
| X7 | 0.568 | 0.507 | 0.134 | 0.373 | 0.148 | 0.398 | 0.109 | 0.435 |
| X8 | 0.129 | 0.227 | 0.250 | 0.103 | 0.257 | −0.063 | 0.095 | −0.015 |
| X9 | 0.065 | 0.147 | 0.171 | 0.121 | 0.168 | −0.075 | −0.096 | −0.061 |
| X10 | 1.000 | 0.683 | 0.052 | 0.437 | 0.079 | 0.612 | 0.138 | 0.649 |
| X11 | 0.683 | 1.000 | 0.159 | 0.342 | 0.152 | 0.445 | 0.048 | 0.465 |
| X12 | 0.052 | 0.159 | 1.000 | 0.310 | 0.967 | −0.140 | −0.004 | −0.023 |
| X13 | 0.437 | 0.342 | 0.310 | 1.000 | 0.318 | 0.267 | −0.041 | 0.352 |
| X14 | 0.079 | 0.152 | 0.967 | 0.318 | 1.000 | −0.119 | 0.025 | −0.011 |
| X15 | 0.612 | 0.445 | −0.140 | 0.267 | −0.119 | 1.000 | 0.279 | 0.771 |
| X16 | 0.138 | 0.048 | −0.004 | −0.041 | 0.025 | 0.279 | 1.000 | 0.177 |
| X17 | 0.649 | 0.465 | −0.023 | 0.352 | −0.011 | 0.771 | 0.177 | 1.000 |

TABLE 4
Inverse matrix

| | X1 | X2 | X3 | X4 | X5 | X6 | X7 | X8 | X9 |
|---|---|---|---|---|---|---|---|---|---|
| X1 | 1.592 | −0.003 | 0.307 | 0.297 | 0.118 | −0.082 | −0.116 | −0.193 | −0.304 |
| X2 | −0.003 | 8.136 | 0.658 | −0.706 | −1.281 | 0.627 | −0.439 | 0.379 | −0.576 |
| X3 | 0.307 | 0.658 | 1.442 | −0.594 | −0.169 | 0.136 | −0.258 | −0.066 | −0.123 |
| X4 | 0.297 | −0.706 | −0.594 | 1.677 | 0.101 | 0.009 | 0.272 | −0.143 | 0.088 |
| X5 | 0.118 | −1.281 | −0.169 | 0.101 | 2.357 | −0.197 | 0.110 | −0.193 | 0.200 |
| X6 | −0.082 | 0.627 | 0.136 | 0.009 | −0.197 | 3.403 | −2.266 | −0.483 | −0.297 |
| X7 | −0.116 | −0.439 | −0.258 | 0.272 | 0.110 | −2.266 | 3.192 | 0.275 | 0.252 |
| X8 | −0.193 | 0.379 | −0.066 | −0.143 | −0.193 | −0.483 | 0.275 | 1.338 | −0.157 |
| X9 | −0.304 | −0.576 | −0.123 | 0.088 | 0.200 | −0.297 | 0.252 | −0.157 | 1.247 |
| X10 | −0.113 | −1.482 | −0.115 | 0.071 | −0.034 | −0.436 | −0.172 | −0.056 | 0.101 |
| X11 | 0.248 | 0.748 | 0.070 | −0.157 | −0.121 | −0.348 | −0.133 | −0.179 | −0.218 |
| X12 | 0.337 | −0.192 | 0.223 | 0.026 | 0.210 | 0.332 | −0.240 | −0.103 | −0.118 |
| X13 | −0.284 | −0.077 | −0.097 | −0.049 | −0.235 | 0.044 | −0.195 | 0.064 | −0.034 |
| X14 | −0.552 | 1.358 | −0.304 | 0.055 | −0.440 | −0.156 | 0.106 | −0.028 | −0.006 |
| X15 | 0.146 | −4.277 | −0.315 | 0.317 | 0.077 | −0.108 | −0.009 | 0.022 | 0.240 |
| X16 | −0.028 | −0.316 | 0.194 | −0.103 | 0.108 | −0.338 | 0.147 | −0.143 | 0.157 |
| X17 | 0.198 | −1.525 | −0.023 | −0.296 | −0.429 | −0.104 | −0.153 | 0.012 | 0.131 |

| | X10 | X11 | X12 | X13 | X14 | X15 | X16 | X17 |
|---|---|---|---|---|---|---|---|---|
| X1 | −0.113 | 0.248 | 0.337 | −0.284 | −0.552 | 0.146 | −0.028 | 0.198 |
| X2 | −1.482 | 0.748 | −0.192 | −0.077 | 1.358 | −4.277 | −0.316 | −1.525 |
| X3 | −0.115 | 0.070 | 0.223 | −0.097 | −0.304 | −0.315 | 0.194 | −0.023 |
| X4 | 0.071 | −0.157 | 0.026 | −0.049 | 0.055 | 0.317 | −0.103 | −0.296 |
| X5 | −0.034 | −0.121 | 0.210 | −0.235 | −0.440 | 0.077 | 0.108 | −0.429 |
| X6 | −0.436 | −0.348 | 0.332 | 0.044 | −0.156 | −0.108 | −0.338 | −0.104 |
| X7 | −0.172 | −0.133 | −0.240 | −0.195 | 0.106 | −0.009 | 0.147 | −0.153 |
| X8 | −0.056 | −0.179 | −0.103 | 0.064 | −0.028 | 0.022 | −0.143 | 0.012 |
| X9 | 0.101 | −0.218 | −0.118 | −0.034 | −0.006 | 0.240 | 0.157 | 0.131 |
| X10 | 3.321 | −1.247 | 0.928 | −0.335 | −1.004 | 0.386 | 0.041 | −0.350 |
| X11 | −1.247 | 2.302 | −0.880 | −0.001 | 0.754 | −0.637 | 0.151 | −0.036 |
| X12 | 0.928 | −0.880 | 16.234 | −0.293 | −15.614 | 0.589 | 0.274 | −0.363 |
| X13 | −0.335 | −0.001 | −0.293 | 1.537 | −0.096 | 0.043 | 0.167 | −0.145 |
| X14 | −1.004 | 0.754 | −15.614 | −0.096 | 16.526 | −0.826 | −0.463 | −0.018 |
| X15 | 0.386 | −0.637 | 0.589 | 0.043 | −0.826 | 5.415 | −0.330 | −0.691 |
| X16 | 0.041 | 0.151 | 0.274 | 0.167 | −0.463 | −0.330 | 1.249 | 0.120 |
| X17 | −0.350 | −0.036 | −0.363 | −0.145 | −0.018 | −0.691 | 0.120 | 3.599 |

TABLE 5
Adjoint matrix

| | X₁ | X₂ | X₃ | X₄ | X₅ | X₆ | X₇ | X₈ | X₉ |
|---|---|---|---|---|---|---|---|---|---|
| X₁ | 2.09E−05 | −3.8E−08 | 4.03E−06 | 3.9E−06 | 1.55E−06 | −1.07E−06 | −1.52E−06 | −2.53E−06 | −4E−06 |
| X₂ | −3.8E−08 | 0.000107 | 8.65E−06 | −9.27E−06 | −1.68E−05 | 8.24E−06 | −5.77E−06 | 4.98E−06 | −7.57E−06 |
| X₃ | 4.03E−06 | 8.65E−06 | 1.89E−05 | −7.81E−06 | −2.22E−06 | 1.78E−06 | −3.4E−06 | −8.65E−07 | −1.62E−06 |
| X₄ | 3.9E−06 | −9.27E−06 | −7.81E−06 | 2.2E−05 | 1.33E−06 | 1.18E−07 | 3.57E−06 | −1.88E−06 | 1.16E−06 |
| X₅ | 1.55E−06 | −1.68E−05 | −2.22E−06 | 1.33E−06 | 3.1E−05 | −2.59E−06 | 1.44E−06 | −2.54E−06 | 2.63E−06 |
| X₆ | −1.07E−06 | 8.24E−06 | 1.78E−06 | 1.18E−07 | −2.59E−06 | 4.47E−05 | −2.98E−05 | −6.35E−06 | −3.91E−06 |
| X₇ | −1.52E−06 | −5.77E−06 | −3.4E−06 | 3.57E−06 | 1.44E−06 | −2.98E−05 | 4.19E−05 | 3.61E−06 | 3.31E−06 |
| X₈ | −2.53E−06 | 4.98E−06 | −8.65E−07 | −1.88E−06 | −2.54E−06 | −6.35E−06 | 3.61E−06 | 1.76E−05 | −2.07E−06 |
| X₉ | −4E−06 | −7.57E−06 | −1.62E−06 | 1.16E−06 | 2.63E−06 | −3.91E−06 | 3.31E−06 | −2.07E−06 | 1.64E−05 |
| X₁₀ | −1.49E−06 | −1.95E−05 | −1.51E−06 | 9.35E−07 | −4.5E−07 | −5.74E−06 | −2.26E−06 | −7.31E−07 | 1.32E−06 |
| X₁₁ | 3.26E−06 | 9.83E−06 | 9.22E−07 | −2.06E−06 | −1.6E−06 | −4.57E−06 | −1.75E−06 | −2.35E−06 | −2.86E−06 |
| X₁₂ | 4.43E−06 | −2.53E−06 | 2.93E−06 | 3.41E−07 | 2.77E−06 | 4.36E−06 | −3.16E−06 | −1.35E−06 | −1.56E−06 |
| X₁₃ | −3.73E−06 | −1.01E−06 | −1.27E−06 | −6.46E−07 | −3.09E−06 | 5.75E−07 | −2.56E−06 | 8.37E−07 | −4.48E−07 |
| X₁₄ | −7.25E−06 | 1.78E−05 | −3.99E−06 | 7.2E−07 | −5.78E−06 | −2.05E−06 | 1.4E−06 | −3.73E−07 | −8.37E−08 |
| X₁₅ | 1.92E−06 | −5.62E−05 | −4.13E−06 | 4.17E−06 | 1.02E−06 | −1.42E−06 | −1.18E−07 | 2.92E−07 | 3.15E−06 |
| X₁₆ | −3.63E−07 | −4.16E−06 | 2.55E−06 | −1.36E−06 | 1.42E−06 | −4.44E−06 | 1.94E−06 | −1.87E−06 | 2.06E−06 |
| X₁₇ | 2.6E−06 | −2E−05 | −3.04E−07 | −3.89E−06 | −5.64E−06 | −1.37E−06 | −2.01E−06 | 1.61E−07 | 1.72E−06 |

| | X₁₀ | X₁₁ | X₁₂ | X₁₃ | X₁₄ | X₁₅ | X₁₆ | X₁₇ |
|---|---|---|---|---|---|---|---|---|
| X₁ | −1.49E−06 | 3.26E−06 | 4.43E−06 | −3.73E−06 | −7.25E−06 | 1.92E−06 | −3.63E−07 | 2.6E−06 |
| X₂ | −1.95E−05 | 9.83E−06 | −2.53E−06 | −1.01E−06 | 1.78E−05 | −5.62E−05 | −4.16E−06 | −2E−05 |
| X₃ | −1.51E−06 | 9.22E−07 | 2.93E−06 | −1.27E−06 | −3.99E−06 | −4.13E−06 | 2.55E−06 | −3.04E−07 |
| X₄ | 9.35E−07 | −2.06E−06 | 3.41E−07 | −6.46E−07 | 7.2E−07 | 4.17E−06 | −1.36E−06 | −3.89E−06 |
| X₅ | −4.5E−07 | −1.6E−06 | 2.77E−06 | −3.09E−06 | −5.78E−06 | 1.02E−06 | 1.42E−06 | −5.64E−06 |
| X₆ | −5.74E−06 | −4.57E−06 | 4.36E−06 | 5.75E−07 | −2.05E−06 | −1.42E−06 | −4.44E−06 | −1.37E−06 |
| X₇ | −2.26E−06 | −1.75E−06 | −3.16E−06 | −2.56E−06 | 1.4E−06 | −1.18E−07 | 1.94E−06 | −2.01E−06 |
| X₈ | −7.31E−07 | −2.35E−06 | −1.35E−06 | 8.37E−07 | −3.73E−07 | 2.92E−07 | −1.87E−06 | 1.61E−07 |
| X₉ | 1.32E−06 | −2.86E−06 | −1.56E−06 | −4.48E−07 | −8.37E−08 | 3.15E−06 | 2.06E−06 | 1.72E−06 |
| X₁₀ | 4.36E−05 | −1.64E−05 | 1.22E−05 | −4.41E−06 | −1.32E−05 | 5.07E−06 | 5.42E−07 | −4.59E−06 |
| X₁₁ | −1.64E−05 | 3.02E−05 | −1.16E−05 | −1.73E−08 | 9.91E−06 | −8.37E−06 | 1.98E−06 | −4.68E−07 |
| X₁₂ | 1.22E−05 | −1.16E−05 | 0.000213 | −3.85E−06 | −0.000205 | 7.74E−06 | 3.6E−06 | −4.77E−06 |
| X₁₃ | −4.41E−06 | −1.73E−08 | −3.85E−06 | 2.02E−05 | −1.27E−06 | 5.62E−07 | 2.19E−06 | −1.9E−06 |
| X₁₄ | −1.32E−05 | 9.91E−06 | −0.000205 | −1.27E−06 | 0.000217 | −1.09E−05 | −6.08E−06 | −2.41E−07 |
| X₁₅ | 5.07E−06 | −8.37E−06 | 7.74E−06 | 5.62E−07 | −1.09E−05 | 7.12E−05 | −4.34E−06 | −9.08E−06 |
| X₁₆ | 5.42E−07 | 1.98E−06 | 3.6E−06 | 2.19E−06 | −6.08E−06 | −4.34E−06 | 1.64E−05 | 1.58E−06 |
| X₁₇ | −4.59E−06 | −4.68E−07 | −4.77E−06 | −1.9E−06 | −2.41E−07 | −9.08E−06 | 1.58E−06 | 4.73E−05 |

TABLE 6
MDs and MDAs for normal group

| | S. No. | | | | | | | | |
|---|---|---|---|---|---|---|---|---|---|
| | 1 | 2 | 3 | 4 | 5 | 6 | 7 | 8 | . . . |
| MD-inverse | 0.378374 | 0.431373 | 0.403562 | 0.500211 | 0.515396 | 0.495501 | 0.583142 | 0.565654 | . . . |
| MD-Adjoint | 0.000005 | 0.000006 | 0.000005 | 0.000007 | 0.000007 | 0.000007 | 0.000008 | 0.000007 | . . . |

| | S. No. | | | | | |
|---|---|---|---|---|---|---|
| | 196 | 197 | 198 | 199 | 200 | Average |
| MD-inverse | 1.74 | 1.75 | 1.78 | 1.76 | 2.36 | 0.995 |
| MD-Adjoint | 0.00002 | 0.00002 | 0.00002 | 0.00002 | 0.00003 | 0.000013 |

TABLE 7
MDs and MDAs for abnormals

| | S. No | | | | | | | | |
|---|---|---|---|---|---|---|---|---|---|
| | 1 | 2 | 3 | 4 | 5 | 6 | 7 | 8 | . . . |
| MD-Inverse | 7.72741 | 8.41629 | 10.29148 | 7.20516 | 10.59075 | 10.55711 | 13.31775 | 14.81278 | . . . |
| MD-adjoint | 0.00010 | 0.00011 | 0.00014 | 0.00009 | 0.00014 | 0.00014 | 0.00017 | 0.00019 | . . . |

| | S. No | | | | | |
|---|---|---|---|---|---|---|
| | 13 | 14 | 15 | 16 | 17 | Average |
| MD-Inverse | 19.65543 | 43.04050 | 78.64045 | 97.27242 | 135.70578 | 30.39451 |
| MD-adjoint | 0.00026 | 0.00057 | 0.00103 | 0.00128 | 0.00178 | 0.00040 |

L₃₂(2³¹) OA is used to accommodate 17 variables. Table 8 gives dynamic S/N ratios for all the combinations of this array with inverse matrix method and adjoint matrix method. Table 9 shows gain in S/N ratios for both the methods. It is clear that gains in S/N ratios is same for both methods. The important variable combination based on these gains is: X₄-X₅-X₁₀-X₁₂-X₁₃-X₁₄-X₁₅-X₁₇. From Table 10, which shows system performance in the form of S/N ratios, it is clear that there is a gain of 1.98 dB units if useful variables are used instead of all the variables. This gain is also exactly same as that obtained in inverse matrix method.

Hence, even if an adjoint matrix method is used, the ultimate results would be the same. However, MDA values are advantageous because it will not take into account the determinant of correlation matrix. In case of multi-collinearity problems, as the determinant tend to become zero, the inverse matrix becomes inefficient giving rise to inaccurate MDs. Such problems can be avoided if MDAs are used based on adjoint matrix method.

TABLE 8
Dynamic S/N ratios for the combinations of L₃₂(2³¹) array

| Run | S/N ratio (Inverse) | S/N ratio (Adjoint) |
|---|---|---|
| 1 | −6.252 | 42.560 |
| 2 | −6.119 | 42.693 |
| 3 | −10.024 | 38.788 |
| 4 | −10.181 | 38.631 |
| 5 | −10.348 | 38.464 |
| 6 | −10.495 | 38.317 |
| 7 | −7.934 | 40.878 |
| 8 | −8.177 | 40.635 |
| 9 | −9.234 | 39.578 |
| 10 | −9.631 | 39.181 |
| 11 | −3.338 | 45.474 |
| 12 | −3.406 | 45.406 |
| 13 | −10.932 | 37.880 |
| 14 | −11.121 | 37.691 |
| 15 | −6.495 | 42.317 |
| 16 | −7.265 | 41.547 |
| 17 | −7.898 | 40.914 |
| 18 | −7.665 | 41.147 |
| 19 | −10.156 | 38.656 |
| 20 | −9.901 | 38.911 |
| 21 | −5.431 | 43.381 |
| 22 | −5.312 | 43.500 |
| 23 | −7.603 | 41.209 |
| 24 | −7.498 | 41.314 |
| 25 | −11.412 | 37.400 |
| 26 | −11.100 | 37.712 |
| 27 | −5.874 | 42.938 |
| 28 | −4.989 | 43.823 |
| 29 | −9.238 | 39.574 |
| 30 | −8.989 | 39.823 |
| 31 | −5.544 | 43.268 |
| 32 | −5.303 | 43.509 |

TABLE 9
Gain in S/N Ratios

| Variable | Level 1 | Level 2 | Gain |
|---|---|---|---|
| Inverse Method | | | |
| X₁ | −8.185 | −7.745 | −0.440 |
| X₂ | −8.187 | −7.742 | −0.445 |
| X₃ | −8.249 | −7.680 | −0.569 |
| X₄ | −7.949 | −7.980 | 0.031 |
| X₅ | −7.069 | −8.860 | 1.791 |
| X₆ | −8.318 | −7.611 | −0.706 |
| X₇ | −7.976 | −7.954 | −0.022 |
| X₈ | −8.824 | −7.105 | −1.718 |
| X₉ | −8.188 | −7.742 | −0.446 |
| X₁₀ | −6.358 | −9.571 | 3.212 |
| X₁₁ | −8.101 | −7.828 | −0.273 |
| X₁₂ | −7.821 | −8.108 | 0.287 |
| X₁₃ | −7.562 | −8.367 | 0.805 |
| X₁₄ | −7.315 | −8.615 | 1.300 |
| X₁₅ | −7.590 | −8.339 | 0.749 |
| X₁₆ | −7.982 | −7.947 | −0.035 |
| X₁₇ | −7.832 | −8.097 | 0.265 |
| Adjoint Method | | | |
| X₁ | 40.627 | 41.067 | −0.440 |
| X₂ | 40.625 | 41.070 | −0.445 |
| X₃ | 40.563 | 41.132 | −0.569 |
| X₄ | 40.863 | 40.832 | 0.031 |
| X₅ | 41.743 | 39.952 | 1.791 |
| X₆ | 40.494 | 41.201 | −0.706 |
| X₇ | 40.836 | 40.858 | −0.022 |
| X₈ | 39.988 | 41.707 | −1.718 |
| X₉ | 40.625 | 41.070 | −0.446 |
| X₁₀ | 42.454 | 39.241 | 3.212 |
| X₁₁ | 40.711 | 40.984 | −0.273 |
| X₁₂ | 40.991 | 40.704 | 0.287 |
| X₁₃ | 41.250 | 40.445 | 0.805 |
| X₁₄ | 41.497 | 40.197 | 1.300 |
| X₁₅ | 41.222 | 40.473 | 0.749 |
| X₁₆ | 40.830 | 40.865 | −0.035 |
| X₁₇ | 40.980 | 40.715 | 0.265 |

TABLE 10
S/N Ratio Analysis

| | | |
|---|---|---|
| S/N ratio-optimal system | 44.54 | dB |
| S/N ratio-original system | 42.56 | dB |
| Gain | 1.98 | dB |

### EXAMPLE 2

The adjoint matrix method is applied to another case with 12 variables. In this example, there are 58 normals and 30 abnormals. The MDs corresponding to normals are computed by using MTS method—the average MD is 0.92. The reason for this discrepancy is the existence of multi-collinearity. This is clear from the correlation matrix (Table 11), which shows that the variables X₁₀, X₁₁ and X₁₂ have high correlations with each other. The determinant of the matrix is also estimated and it is found to be 8.693×10⁻¹² (close to zero), indicating that the matrix is almost singular. Presence of multi-collinearity will also affect the other stages of the MTS method. Hence, adjoint matrix method is used to perform the analysis.

Adjoint Matrix Method

The adjoint of correlation matrix is shown in Table 12.

TABLE 11
Correlation Matrix

| | X₁ | X₂ | X₃ | X₄ | X₅ | X₆ | X₇ | X₈ | X₉ | X₁₀ | X₁₁ | X₁₂ |
|---|---|---|---|---|---|---|---|---|---|---|---|---|
| X₁ | 1 | 0.358 | −0.085 | −0.024 | 0.005 | 0.057 | −0.149 | −0.128 | −0.046 | 0.105 | −0.055 | −0.055 |
| X₂ | 0.358 | 1 | 0.014 | 0.022 | 0.003 | −0.097 | −0.271 | −0.079 | 0.061 | 0.325 | 0.023 | 0.023 |
| X₃ | −0.085 | 0.014 | 1 | 0.0769 | 0.0708 | 0.0577 | 0.3138 | 0.1603 | 0.0815 | 0.4945 | 0.5286 | 0.5333 |
| X₄ | −0.024 | 0.022 | 0.0769 | 1 | −0.135 | −0.018 | 0.296 | −0.206 | 0.062 | 0.597 | 0.624 | 0.622 |
| X₅ | 0.005 | 0.003 | 0.0708 | −0.135 | 1 | 0.123 | 0.264 | 0.114 | 0.053 | 0.536 | 0.560 | 0.559 |
| X₆ | 0.057 | −0.097 | 0.0577 | −0.018 | 0.123 | 1 | 0.353 | 0.055 | 0.056 | 0.063 | 0.096 | 0.096 |
| X₇ | −0.149 | −0.271 | 0.3138 | 0.296 | 0.264 | 0.353 | 1 | 0.103 | 0.092 | 0.395 | 0.508 | 0.508 |
| X₈ | −0.128 | −0.079 | 0.1603 | −0.206 | 0.114 | 0.055 | 0.103 | 1 | −0.153 | −0.032 | −0.002 | −0.0004 |
| X₉ | −0.046 | 0.061 | 0.0815 | 0.062 | 0.053 | 0.056 | 0.092 | −0.153 | 1 | 0.116 | 0.104 | 0.104 |
| X₁₀ | 0.105 | 0.325 | 0.4945 | 0.597 | 0.536 | 0.063 | 0.395 | −0.032 | 0.116 | 1 | 0.951 | 0.951 |
| X₁₁ | −0.055 | 0.023 | 0.5286 | 0.624 | 0.560 | 0.096 | 0.508 | −0.002 | 0.104 | 0.951 | 1 | 0.999 |
| X₁₂ | −0.055 | 0.023 | 0.5333 | 0.622 | 0.559 | 0.096 | 0.508 | −0.0004 | 0.104 | 0.951 | 0.999 | 1 |

TABLE 12
Adjoint Matrix

| | X₁ | X₂ | X₃ | X₄ | X₅ | X₆ |
|---|---|---|---|---|---|---|
| X₁ | 1.00912E−10 | 4.70272E−10 | 1.61623E−10 | 2.76032E−10 | 2.57713E−10 | −5.48951E−12 |
| X₂ | 4.70263E−10 | 2.50034E−09 | 9.18237E−10 | 1.55621E−09 | 1.45406E−09 | −2.10511E−11 |
| X₃ | 1.61527E−10 | 9.17746E−10 | 1.06463E−09 | 1.63137E−09 | 1.50922E−09 | 5.28862E−13 |
| X₄ | 2.7594E−10 | 1.55576E−09 | 1.63154E−09 | 2.56985E−09 | 2.37158E−09 | −3.57245E−13 |
| X₅ | 2.57631E−10 | 1.45366E−09 | 1.50939E−09 | 2.37159E−09 | 2.20389E−09 | −1.73783E−12 |
| X₆ | −5.4903E−12 | −2.10556E−11 | 5.23064E−13 | −3.64155E−13 | −1.74411E−12 | 1.06058E−11 |
| X₇ | 5.04604E−12 | 2.83284E−11 | 2.05079E−11 | 3.50574E−11 | 3.34989E−11 | −4.37759E−12 |
| X₈ | 7.12086E−13 | −3.11071E−12 | −9.19606E−12 | −1.10978E−11 | −1.29962E−11 | −1.97598E−13 |
| X₉ | 1.43722E−12 | 8.07304E−13 | −1.32908E−11 | −1.89556E−11 | −1.78591E−11 | −5.79657E−13 |
| X₁₀ | −1.66565E−09 | −8.74446E−09 | −3.1875E−09 | −5.4102E−09 | −5.05514E−09 | 7.53194E−11 |
| X₁₁ | 7.60305E−10 | 4.38609E−09 | 5.67096E−09 | 6.22205E−09 | 5.62443E−09 | 5.56545E−13 |
| X₁₂ | 4.14615E−10 | 1.61673E−09 | −5.08692E−09 | −4.90701E−09 | −4.36272E−09 | −6.98298E−11 |
| | X₇ | X₈ | X₉ | X₁₀ | X₁₁ | X₁₂ |
| X₁ | 5.043E−12 | 7.14809E−13 | 1.43647E−12 | −1.66567E−09 | 7.66095E−10 | 4.08691E−10 |
| X₂ | 2.83118E−11 | −3.09613E−12 | 8.03373E−13 | −8.7444E−09 | 4.41674E−09 | 1.58527E−09 |
| X₃ | 2.04944E−11 | −9.18812E−12 | −1.3292E−11 | −3.18575E−09 | 5.68418E−09 | −5.10159E−09 |
| X₄ | 3.50392E−11 | −1.10855E−11 | −1.89581E−11 | −5.40857E−09 | 6.24469E−09 | −4.93127E−09 |
| X₅ | 3.34823E−11 | −1.29848E−11 | −1.78615E−11 | −5.0537E−09 | 5.64554E−09 | −4.38529E−09 |
| X₆ | −4.37752E−12 | −1.97695E−13 | −5.79622E−13 | 7.5335E−11 | 3.17881E−13 | −6.9595E−11 |
| X₇ | 1.58563E−11 | −1.42556E−12 | −1.00253E−12 | −8.62928E−11 | −1.25906E−10 | 1.486E−10 |
| X₈ | −1.42569E−12 | 1.01743E−11 | 1.84668E−12 | 1.04492E−11 | 1.34899E−10 | −1.25096E−10 |
| X₉ | −1.00246E−12 | 1.84666E−12 | 9.46854E−12 | −6.93471E−12 | −2.47767E−11 | 5.98708E−11 |
| X₁₀ | −8.62349E−11 | 1.03982E−11 | −6.92086E−12 | 3.07209E−08 | −1.50768E−08 | −6.10343E−09 |
| X₁₁ | −1.26294E−10 | 1.35001E−10 | −2.47494E−11 | −1.49692E−08 | 2.88114E−07 | −2.83899E−07 |
| X₁₂ | 1.48962E−10 | −1.25168E−10 | 5.98339E−11 | −6.21375E−09 | −2.8383E−07 | 2.97854E−07 |

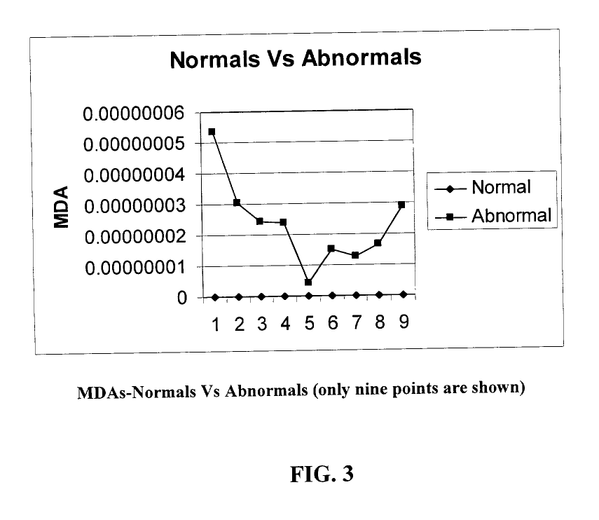

After computing MDA values for normals, the measurement scale is validated by computing abnormal MDA values. FIG. 3 indicates that there is a clear distinction between normals and abnormals.

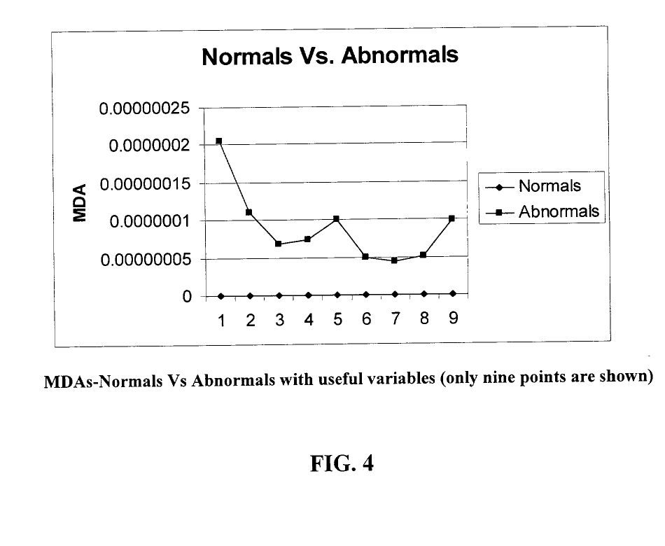

In the next step, important variables are selected using L₁₆(2¹⁵) array. The S/N ratio analysis was performed based on larger-the-better criterion in usual way. The gains in S/N ratios are shown in Table 13. From this table, it is clear that the variables X₁-X₂-X₃-X₄-X₆-X₁₀-X₁₁-X₁₂ have positive gains and hence they are important. The confirmation run with these variables (FIG. 4) indicates that distinction (between normals and abnormals) is very good.

TABLE 13
Gain in S/N ratio

| Variable | Level 1 | Level 2 | Gain |
|---|---|---|---|
| X₁ | −102.90 | −105.01 | 2.12 |
| X₂ | −103.53 | −104.38 | 0.86 |
| X₃ | −103.84 | −104.07 | 0.22 |
| X₄ | −103.72 | −104.19 | 0.47 |
| X₅ | −104.04 | −103.86 | −0.18 |
| X₆ | −103.87 | −104.04 | 0.16 |
| X₇ | −104.18 | −103.72 | −0.46 |
| X₈ | −104.14 | −103.77 | −0.37 |
| X₉ | −104.33 | −103.58 | −0.76 |
| X₁₀ | −103.51 | −104.40 | 0.90 |
| X₁₁ | −103.78 | −104.13 | 0.35 |
| X₁₂ | −103.43 | −104.48 | 1.05 |

Therefore, adjoint matrix method can safely replace inverse matrix method as it is as efficient as inverse matrix method in general and more efficient when there are problems of multi-collinearity.

### EXAMPLE 3

(Illustration of MMD Method)

From the 17 variables, eight subsets (as shown in Table 14) are selected. These subsets are selected to illustrate the methodology; there is no rational for this selection. It is to be noted that the number of variables in each subset are not the same.

TABLE 14
Subsets for MMD analysis

| Subset | Variables |
|---|---|
| S₁ | X₁-X₂-X₃-X₄ |
| S₂ | X₅-X₆-X₇-X₈ |
| S₃ | X₉-X₁₀-X₁₁-X₁₂ |
| S₄ | X₁₃-X₁₄-X₁₅-X₁₆-X₁₇ |
| S₅ | X₃-X₄-X₅-X₆ |
| S₆ | X₁₀-X₁₁-X₁₂-X₁₃-X₁₄-X₁₅ |
| S₇ | X₁₄-X₁₅-X₁₆-X₁₇ |
| S₈ | X₂-X₅-X₇-X₁₀-X₁₂-X₁₃-X₁₄-X₁₅ |

For each subset, Mahalanobis distances are computed with the help of correlation matrices of respective variables. Therefore, we have eight sets of MDs (for normals and abnormals) corresponding to the subsets. The √MDs provide data corresponding to the subsets that are considered as control factors. Tables 15 and 16 show sample data (√MDs) for normals and abnormals.

TABLE 15
MDs for normals (sample data)

| S. No | S₁ | S₂ | S₃ | S₄ | S₅ | S₆ | S₇ | S₈ |
|---|---|---|---|---|---|---|---|---|
| 1 | 0.873 | 0.545 | 0.707 | 0.756 | 0.796 | 0.505 | 0.832 | 0.574 |
| 2 | 0.762 | 0.540 | 0.929 | 0.710 | 0.499 | 0.688 | 0.606 | 0.807 |
| 3 | 1.022 | 0.688 | 0.550 | 0.623 | 0.955 | 0.479 | 0.697 | 0.613 |
| 4 | 1.102 | 0.544 | 0.769 | 0.740 | 1.225 | 0.648 | 0.827 | 0.681 |
| 5 | 1.022 | 0.640 | 0.602 | 0.888 | 0.815 | 0.782 | 0.934 | 0.695 |
| 196 | 1.041 | 0.786 | 1.691 | 1.513 | 0.500 | 1.550 | 1.539 | 1.411 |
| 197 | 1.467 | 1.310 | 2.101 | 1.201 | 1.457 | 1.481 | 0.611 | 1.373 |
| 198 | 1.086 | 1.278 | 0.974 | 1.406 | 1.410 | 1.834 | 0.994 | 1.648 |
| 199 | 1.238 | 0.999 | 1.107 | 1.061 | 1.206 | 1.132 | 0.964 | 1.700 |
| 200 | 1.391 | 0.924 | 0.979 | 0.680 | 1.094 | 2.156 | 0.750 | 1.844 |

TABLE 16
MDs for abnormals (sample data)

| S.No | S₁ | S₂ | S₃ | S₄ | S₅ | S₆ | S₇ | S₈ |
|---|---|---|---|---|---|---|---|---|
| 1 | 1.339 | 2.930 | 2.610 | 3.428 | 2.574 | 3.277 | 2.913 | 3.734 |
| 2 | 1.491 | 3.469 | 1.931 | 1.511 | 3.267 | 3.388 | 1.687 | 3.932 |
| 3 | 1.251 | 2.700 | 0.742 | 2.631 | 2.447 | 3.322 | 2.660 | 4.365 |
| 4 | 2.124 | 2.507 | 2.041 | 3.240 | 2.518 | 3.058 | 2.009 | 3.395 |
| 5 | 1.010 | 2.182 | 2.867 | 1.279 | 1.861 | 4.035 | 1.090 | 4.440 |
| 13 | 1.769 | 2.819 | 6.544 | 2.153 | 2.352 | 6.023 | 2.177 | 5.776 |
| 14 | 1.898 | 2.045 | 3.817 | 4.551 | 2.443 | 10.213 | 1.969 | 9.275 |
| 15 | 1.624 | 12.681 | 2.116 | 3.672 | 12.248 | 9.064 | 1.202 | 11.426 |
| 16 | 5.453 | 13.314 | 3.630 | 1.022 | 13.515 | 10.095 | 1.108 | 12.121 |
| 17 | 4.511 | 16.425 | 5.489 | 3.684 | 12.027 | 11.142 | 2.264 | 10.939 |

After arranging the data (VMDs) in this manner, MMD analysis is carried out. In this analysis, MMDs are Mahalanobis distances obtained from √MDs. Table 17 and 18 provide sample values of MMDs for normals and abnormals respectively.

TABLE 17
MMDs for normals (sample values)

| Condition | 1 | 2 | 3 | 4 | 5 | 6 | 7 | 8 | 9 | 10 | ... | 198 | 199 | 200 |
|---|---|---|---|---|---|---|---|---|---|---|---|---|---|---|
| MMD | 0.558 | 0.861 | 0.425 | 0.786 | 0.413 | 1.655 | 0.357 | 0.660 | 0.641 | 0.717 | ... | 2.243 | 2.243 | 4.979 |

TABLE 18
MMDs for abnormals (sample values)

| Condition | 1 | 2 | 3 | 4 | 5 | 6 | 7 | 8 | 9 | 10 | ... | 15 | 16 | 17 |
|---|---|---|---|---|---|---|---|---|---|---|---|---|---|---|
| MMD | 22.52 | 29.86 | 30.61 | 23.47 | 27.05 | 57.12 | 61.61 | 52.64 | 50.77 | 66.15 | ... | 515.50 | 601.30 | 592.37 |

The next step to assign the subsets to the columns of a suitable orthogonal array. Since there are eight subsets, L₁₂(2¹¹) array was selected. The abnormal MMDs are computed for each run of this array. After performing average response analysis, gains in S/N ratios are computed for all the subsets. These details are shown in Table 19.

TABLE 19
Gain in S/N ratios

| | Level 1 | Level 2 | Gain |
|---|---|---|---|
| S₁ | 15.498 | 18.053 | −2.555 |
| S₂ | 17.463 | 16.089 | 1.374 |
| S₃ | 16.712 | 16.839 | −0.127 |
| S₄ | 15.925 | 17.627 | −1.702 |
| S₅ | 17.626 | 15.926 | 1.700 |
| S₆ | 17.243 | 16.309 | 0.934 |
| S₇ | 15.683 | 17.869 | −2.186 |
| S₈ | 18.556 | 14.996 | 3.560 |

From this table it is clear that S₈ has highest gain indicating that this is very important subset. It should be noted that the variables in this subset are same as the useful variable obtained from MTS method. This example is a simple case where we have only 17 variables and therefore here, MMD method may not be necessary. However, in complex cases, with several hundreds of variables, MMD method is more appropriate and reliable.

Publications mentioned in the specification are indicative of the levels of those skilled in the art to which the invention pertains. These publications are incorporated herein by reference to the same extent as if each individual publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A process for multivariate data analysis comprising the steps of:
using an adjoint matrix to compute a new distance for a data set in a Mahalanobis space; and
determining the relation of a datum to the Mahalanobis space.

2. The process of claim 1 wherein said adjoint matrix satisfies the relationship: A⁻¹=(1/det. A)A_{adj} where A is a square matrix, 1/det. A is the reciprocal determinant of A, A⁻¹ is inverse matrix of A and A_{adj} is the adjoint matrix of A.

3. The process of claim 1 wherein said data set is associated with variables.

4. The process of claim 1 further comprising the step of considering signal to noise ratio values prior to determining the relation of a datum to the Mahalanobis space with useful variables.

5. The process of claim 1 further comprising the step of: finding a useful variable set for a given condition.

6. The process of claim 5 wherein the useful variable set differentiates abnormal observations in the Mahalanobis space for said given condition.

7. A multivariable data analysis process comprising the steps of:
defining a set of variables relating to a condition;
collecting a data set of the set of variables for a normal group;
computing standardized values of the set of variables of the normal group;
constructing a Mahalanobis space for the normal group;
computing a distance for an abnormal value outside the Mahalanobis space;
identifying important variables from the set of variables using orthogonal arrays and signal to noise ratios; and
monitoring conditions in future based upon the important variables.

8. The process of claim 7 wherein said condition is the medical condition of a patient.

9. The process of claim 7 wherein said condition is the quality of a manufactured product.

10. The process of claim 7 wherein said condition is voice recognition.

11. The process of claim 7 wherein said condition is TV picture recognition.

12. A multivariate data analysis process comprising the steps of:
defining a plurality of subsets from a set of variables relating to a condition;
calculating Mahalanobis distance for a normal value and an abnormal value for each of said plurality of subsets;
computing a square root of each of the Mahalanobis distances;
computing a multiple Mahalanobis distance from said square roots; and
selecting an important subset based on signal to noise ratios attained for each run of an orthogonal array of said multiple Mahalanobis distances.

13. The process of claim 12 wherein said condition is the medical condition of a patient.

14. The process of claim 12 wherein said condition is the quality of a manufactured product.

15. The process of claim 12 wherein said condition is voice recognition.

16. The process of claim 12 wherein said condition is TV picture recognition.
